(19) United States
(12) Patent Application Publication
(10) Pub. No.: US 2016/0137303 A1
(43) Pub. Date: May 19, 2016

(54) SYSTEMS AND METHODS FOR USING COMPUTER VISION FOR PARAFOIL FLIGHT CONTROL

(71) Applicant: LOGOS TECHNOLOGIES, INC., Fairfax, VA (US)

(72) Inventors: Wade Pullam, Fairfax, VA (US); Patrick Baker, Fairfax, VA (US); Dave Fields, Fairfax, VA (US); Bradley Burns, Fairfax, VA (US); Sllete Amouzou, Fairfax, VA (US); Bryan Schulz, Fairfax, VA (US); Jim Engier, Fairfax, VA (US)

(21) Appl. No.: 14/900,087

(22) PCT Filed: Jun. 13, 2014
(86) PCT No.: PCT/US14/42210

§ 371 Date: Dec. 18, 2015

Related U.S. Application Data
(60) Provisional application No. 61/836,236, filed on Jun. 18, 2013.

(51) Int. Cl. B64D 17/34; G06K 9/00; G05D 1/10

(52) U.S. Cl. CPC B64D 17/34; G05D 1/105; G06K 9/00791

(57) ABSTRACT

Disclosed herein are systems and methods for using computer vision for parafoil flight control. According to an aspect, a method includes capturing an image of a parafoil including multiple indicator points distributed thereon. The method further includes determining positioning of the indicator points based on the captured image. The method further includes determining a condition of the parafoil based on the positioning of the indicator points. The method further includes controlling flight inputs based on the condition of the parafoil.

### CROSS REFERENCE TO RELATED APPLICATIONS

This application is a 35 USC 371 application of PCT International Patent Application No. PCT/US14/42210, filed Jun. 13, 2014 and titled SYSTEMS AND METHODS FOR USING COMPUTER VISION FOR PARAFOIL FLIGHT CONTROL, which claims priority to U.S. Provisional Patent Application No. 61/836,236, filed on Jun. 18, 2013 and titled PARAFOIL FLIGHT CONTROL IMPROVEMENT USING COMPUTER VISION; the contents of which are hereby incorporated herein by reference in their entireties.

### TECHNICAL FIELD

The present subject matter relates to parafoil flight control, and more specifically, to systems and methods for using computer vision for parafoil flight control.

### BACKGROUND

The parafoil is a wing shaped parachute capable of steerable, controlled descent. Essentially, the parachute aspect of the parafoil causes the parafoil to exhibit a gradual descent, while the wing aspect of the parafoil permits the parafoil to have a guided flight path. The flight path of the parafoil can be controlled by tugging and/or releasing lines coupled to the left trailing edge and right trailing edge of the parafoil. Specifically, the parafoil can be made to turn to the left if the left trailing edge line is tugged or pulled. Similarly, the parafoil can be made to turn to the right if the right trailing edge line is tugged or pulled. The parafoil can even be made to momentarily rise, or at least change its pitch upward if both the left and right trailing edge lines are tugged or pulled.

Because of the ability to control the flight path of the parafoil, parafoils have been used for guided drops of a payload. In order to successfully land the parafoil at or near some target, however, an individual or a guided electronic flight control system is needed to control the trailing edge lines so as to guide the parafoil with the requisite accuracy. Controlling the trailing edge lines is performed on the parafoil based on the location of the target, the altitude of the parafoil, the forward and transverse speeds of the parafoil, the roll, roll rate, yaw, yaw rate, pitch and pitch rate of the parafoil and the presence of winds. This is a complex task which can result in a complex system with frequent system and parafoil failures.

Previous flight control systems have been used to control the parafoil. Control of the parafoil is based on sensor data from multiple sensors on the payload (gondola) and may also be supplemented by sensor data from the parafoil as well. Previous flight control systems have used numerous small, wireless accelerometers installed on the parafoil or the payload to acquire this data. These approaches tend to require complex systems that have a high failure rate, causing difficulties in operation. In addition, the present technologies are both expensive in terms of equipment cost and payload damage upon system failure that may include mid-flight parafoil collapse.

For at least the foregoing reasons, there is a need for improved systems and methods for parafoil flight control.

### SUMMARY

Disclosed herein are systems and methods for using computer vision for parafoil flight control. According to an aspect, a method comprising capturing an image of a parafoil. The method further includes determining positioning of multiple indicator points on the parafoil based on the captured image. The method further includes determining a condition of the parafoil based on the positioning of the indicator points. The method further includes controlling flight inputs based on the condition of the parafoil.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1A is a perspective view of an example parafoil in flight;

FIG. 1B is a perspective view of the parafoil of FIG. 1A in a left turn during flight;

FIG. 1C is a perspective view of the parafoil of FIG. 1A in a right turn during flight;

FIG. 1D is a cross-sectional view of an example parafoil and payload system using an eight (8) degree-of-freedom (DOF) model;

FIG. 1E is a rear view of an example parafoil and payload system using differential pitch and differential yaw of the parafoil in an eight (8) DOF model;

FIG. 2 illustrates a schematic diagram of an example flight control system for controlling the flight of a parafoil and payload according to embodiments of the present subject matter;

FIG. 3 is a flowchart of an example method of controlling the flight of a parafoil and payload using a flight control system according to embodiments of the present subject matter;

FIG. 4 is a flowchart of an example method of controlling the flight of the parafoil and payload using a flight control system in accordance with embodiments of the present subject matter;

FIG. 5A is a front view of an example flight control system in accordance with embodiments of the present subject matter;

FIG. 5B is a side view of the system shown in FIG. 5A;

FIG. 6A is a perspective view showing an example of a flight control system determining differential yaw in accordance with embodiments of the present subject matter;

FIG. 6B is a perspective showing an example of the flight control system determining differential pitch; and

FIG. 6C is a perspective view showing an example of the flight control system determining parafoil deformation.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present subject matter. A computing device may be, for example, a processing circuit for the detection of a change in voltage level or change in measured capacitance across a circuit. In another example, a computing device may be a server or other computer located within a commercial, residential or outdoor environment and communicatively connected to other computing devices for using computer vision for parafoil flight control. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

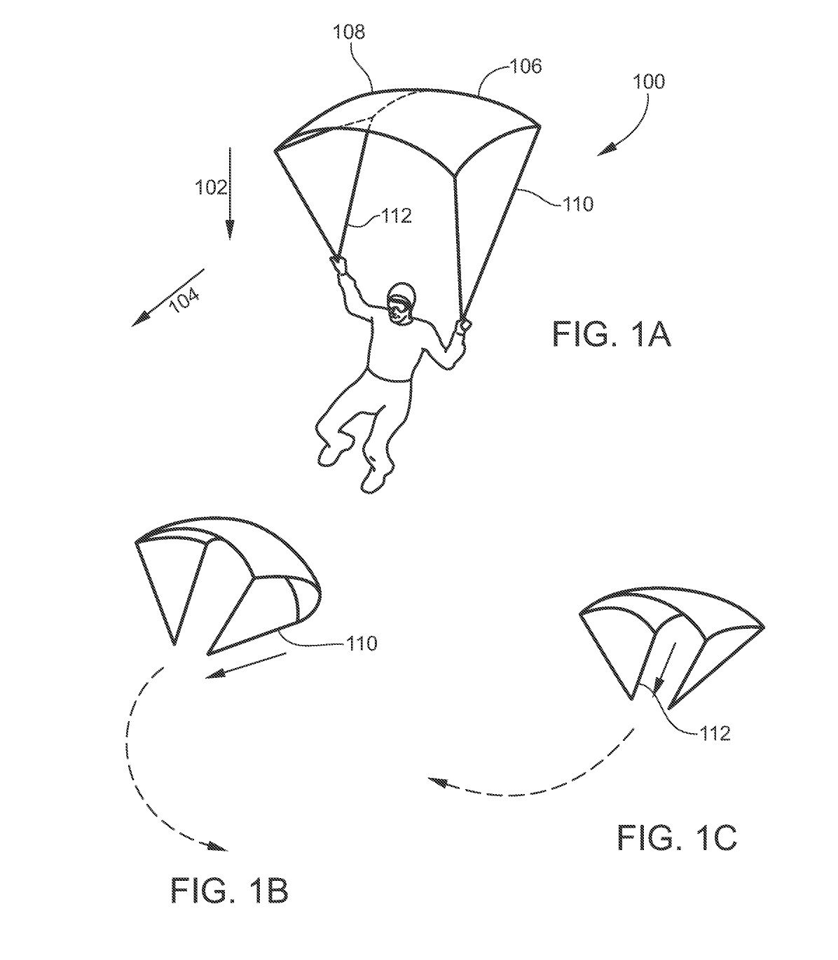

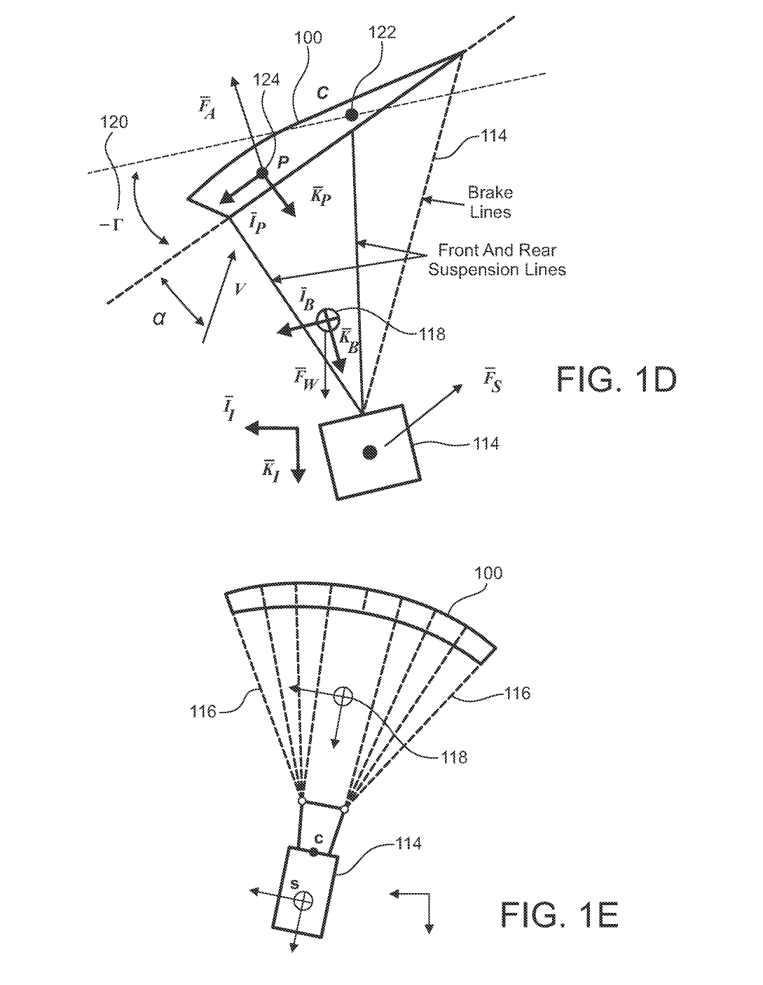

To illustrate the operation of parafoils, FIG. 1A-1E are provided. FIG. 1A is a perspective view showing an example of a parafoil 100 in flight. The parafoil 100 is a wing shaped parachute capable of steerable, controlled descent. Essentially, the parachute aspect of the parafoil 100 causes the parafoil 100 to exhibit a gradual descent, generally in the direction indicated by arrow 102, while the wing aspect of the parafoil 100 permits the parafoil 100 to have a guided flight path, generally indicated by arrow 104. The flight path 104 of the parafoil 100 can be controlled by tugging/releasing lines coupled to the left trailing edge 106 and the right trailing edge 108 of the parafoil 100. Specifically, as observed in FIG. 1B, the parafoil 100 can be made to turn to the left if the left trailing edge line 110 is tugged or pulled. Likewise, referring to FIG. 1C, the parafoil 100 can be made to turn to the right if the right trailing edge line 112 is tugged/pulled. The parafoil 100 can even be made to momentarily rise, or at least change its pitch upward if both the left and right trailing edge lines 110, 112 are tugged or pulled.

Parafoils 100 have been used for guided drops as a consequence of the ability to control their flight path. In order to successfully land the parafoil 100 at or near some target, however, an individual or a guided electronic flight control system may need to control the trailing edge lines 110, 112 so as to guide the parafoil 100 with the requisite accuracy. Controlling the trailing edge lines 110, 112 is performed on the parafoil 100 based on the location of the target, the altitude of the parafoil 100, the forward and transverse speeds of the parafoil 100, the roll, roll rate, yaw, yaw rate, pitch and pitch rate of the parafoil 100 and the presence of winds.

With regard to FIG. 1D illustrates a cross-sectional view showing another example parafoil 100 and a payload system 114 using an eight (8) degree-of-freedom (DOF) model. The combined system of the parafoil 100 and the payload 114 is modeled with eight (8) DOF in FIG. 1D, including three inertial position rate components of the total system mass center as well as the three Euler orientation angles, plus differential pitch, and differential yaw relative to the payload. With the exception of movable parafoil brakes 116, the parafoil 100 may be considered to be a substantially fixed shape once it has completely inflated. A body frame is fixed at the system mass center 118 with I_{B} forward and aligned with the top of the payload 114. Orientation of the parafoil 100 with respect to the payload 114 may be defined as the incidence angle 120 and may be considered a control variable. Rotation of the parafoil 100 about point C 122 allows tilting of the parafoil lift and drag vectors resulting in changes in the equilibrium glide slope. The parafoil rotation point C 122 is in line with the rear suspension lines so that by shortening the front lines and lengthening the brake lines, a pure canopy rotation can be achieved. The aerodynamic center is defined as P 124. FIG. 1E illustrates a rear view of the parafoil 100 shown in FIG. 1D.

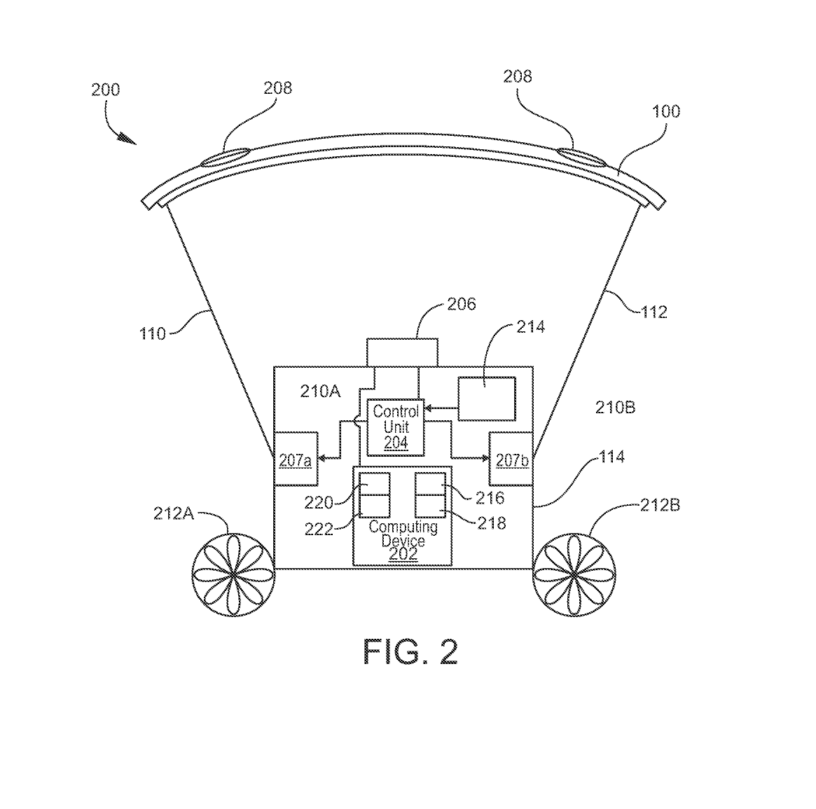

In accordance with embodiments of the present subject matter, FIG. 2 illustrates a schematic diagram of an example flight control system 200 for controlling the flight of the parafoil 100 and payload 114. Referring to FIG. 2, the flight control system 200 includes a computing device 202, a control unit 204, one or more digital imaging devices 206. The flight control system 200 also includes multiple indicator points 208 attached to the parafoil 114 as markers. Although only two indicators points are shown in FIG. 2, it should be understood that the system 200 may include any number of indicator points distributed on the parafoil. As a non-limiting example, the indicator points 208 may be reflective markers, patterns, or other identifiable features that may be recognized in an image captured by the digital imaging device(s) 206. Additionally, infrared or visible light may be used in combination with the indicator points 208.

With continued reference to FIG. 2, the flight control system may use an eight (8) degrees-of-freedom (8-DOF) simulation the same or similar to the simulation discussed in Slegers, Nathan, “Use of Variable Incidence Angle for Glide Slope Control of Autonomous Parafoils,” Journal of Guidance, Control, and Dynamics, Vol. 31, No. 3, May-June 2008. The 8-DOF includes 3 angles and 3 rates for the parafoil 100, body mass center, and the payload 114. The 8-DOF also includes differential pitch and differential yaw of the parafoil 100, as measured relative to the payload (e.g., gondola) 114. These 8-DOF can be used to model the physical system.

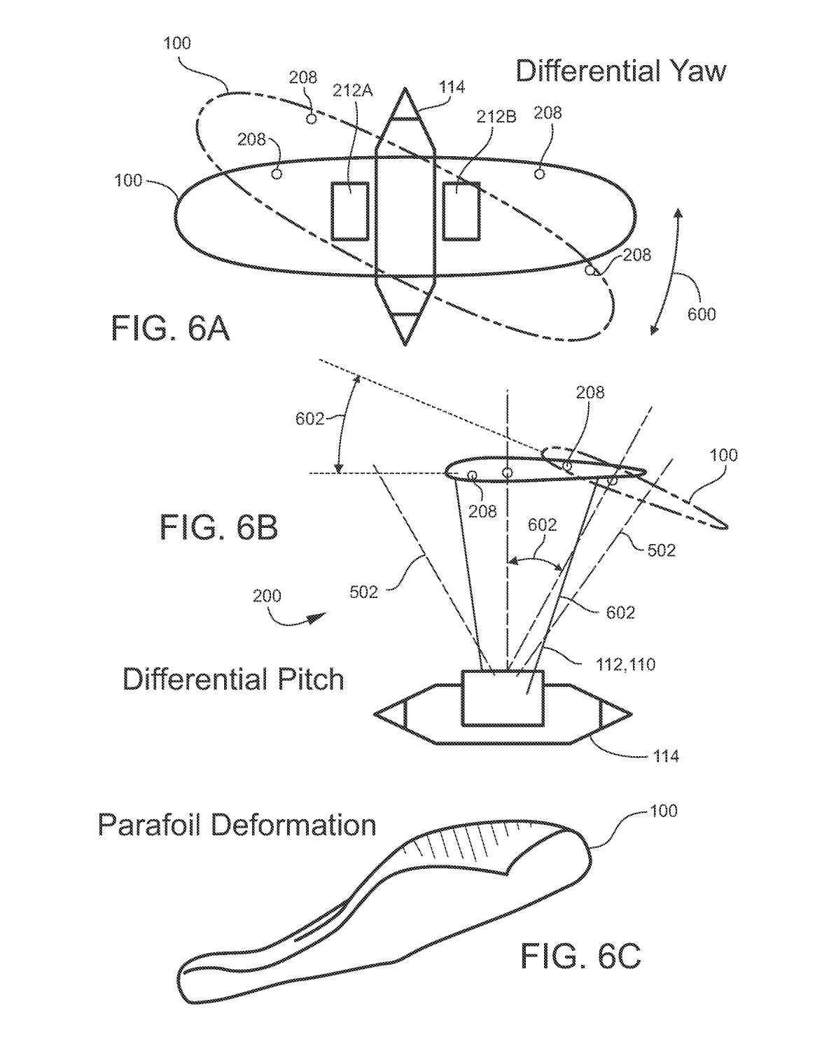

With continued reference to FIG. 2, the digital imaging device 206 may be coupled via wired or wireless electronic coupling to the computing device 202. The computing device 202 may be configured to receive captured, digital images from the digital imaging device 206. The digital image devices may be situated such that images of all or a portion of the parafoil 100 can be captured. The captured images may include one or more of the indicator points 208. The computing device 202 may also be configured to control the type, resolution or rate of imaging of the digital imaging device(s) 206. The digital imaging device(s) 206 may be configured to capture individual images or a continuous set of images during operation of the system 200. The continuous set of images may be recorded at any frame rate, including high speed video of 60 fps, as an example. The frame rate may vary to accommodate processing limitations or other sampling requirements of the computing device 202. The computing device 202 may identify the indicator points 208 in the captured digital images via image processing instructions executed by the computing device 202. The recorded digital images are processed to determine relative positioning of the indicator points 208. As will be described in greater detail herein (e.g., FIGS. 6A, 6B, and 6C), the relative positioning of the indicator points 208 may be measured relative to the digital image frame or the payload 114. By determining the relative positioning of the indicator points 208 both differential yaw and differential pitch may be determined, as described in further detail herein such as the description of FIGS. 6A, 6B, and 6C. The computing device 208 may also be configured to determine the differential yaw and differential pitch over a period of time, thus determining the differential yaw rate and the differential pitch rate. In this manner, the computing device 202 may control the parafoil 100 using the control unit 204 and a plurality of actuators 210A, 210B, wherein the control unit 204 can control actuators 210A, 210B.

With continued reference to FIG. 2, the actuators 210A, 210B may be configured to alter the positioning of the left trailing edge line 110 and the right trailing edge line 112 in order to control the configuration of the parafoil 114 and subsequent flight path of the flight control system 200 and payload 114. The flight control system 200 may process the received digital images in a control loop from 0.1 Hz to 300 Hz. The control loop may include the receiving of the digital image from the digital imaging device 206, determination of differential yaw and/or differential pitch as calculated by the computing device 202 and subsequent processing of a control request by the control unit 204 and the plurality of actuators 210A, 210B. Alternatively, the control loop may include the control unit 204 controlling one or more propulsion units 212A, 212B mounted on either the payload 114 or parafoil 100. Propulsion of the system 100 may be made by an electric or fueled fan motor, as an example. Any other suitable propulsion may be utilized, including a jet/rocket or other propulsion means using a combustible or alternative fuel. A propulsion unit 212A, 212B may be controlled independently of another source of propulsion in the case there are propulsion units 212A, 212B. In this manner, greater control of the parafoil 100 and payload 114 flight path may be achieved. Additionally, the system 200 may be configured to control the actuators 210A, 210B or the propulsion units 212A, 212B independently of each other. It is noted that the computing device 202 may be configured to control the plurality of actuators 210A, 210B, wherein no propulsion is used. In the example that no propulsion is used, the parafoil 100 may be guided by the actuators 210A, 210B.

With continued reference to FIG. 2, the flight control system 200 may be configured to determine the rigidity of the parafoil 100. It may be desired to determine the rigidity of the parafoil 100 such that proper inflation and/or guided flight may be maintained. The proper inflation and/or guided flight path may be maintained via the computing device 202 and the control unit 204 based on the determination of the rigidity of the parafoil 100. The rigidity of the parafoil 100 may be determined by the computing device 208 by processing the received digital images from the digital imaging device 206. The processing of the received digital images may be performed by the computing device 208 by determining the positioning of the indicator points 208 on the parafoil 100. Alternatively, or in addition to the positioning of the indicator points 208, the rigidity of the parafoil 100 may be determined by the shape of the parafoil 100. For example, a captured image of all or a portion of the parafoil 100 may be used to determine rigidity. Additionally, the flight control system 200 may also include one or more sensors 214 used for determination of the payload 114 orientation. The sensor(s) 214 may be, for example, an accelerometer, gyroscope, or other suitable sensor.

With continued regard to FIG. 2, the computing device 202 may include hardware, software, firmware, or combinations thereof. For example, the computing device 202 may include a processor 216 and memory 218 for implementing the functionality disclosed herein. The processor 216 may be used to make the necessary calculations for determining the flight path, differential pitch, differential yaw, and any other necessary calculation to maintain proper rigidity and control of the parafoil 100. The computing device 202 may also include a wireless communications unit 220 for transmitting or receiving captured image data, telemetry data or other flight, parafoil 100 or payload 114 data for monitoring and controlling the flight control system 200. The computing device 202 may also receive program instructions via the wired or wireless connection. The computing device 202 may also comprise storage 222 (e.g., memory) for storing flight data, including captured image data, telemetry data or other flight, parafoil or payload data. The computing device 202 may be configured to transmit any of the capture image data, telemetry data or other flight, parafoil 100 or payload 114 data. Additionally, the computing device 202 may be configured to receive control instructions via a wired or wireless connection. In this manner, the flight control system 200 may be controlled remotely.

With continued reference to FIG. 2, the lift-to-drag ratio, or L/D ratio, is the amount of lift generated by a wing or vehicle, divided by the drag it creates by moving through the air. A higher or more favorable L/D ratio is typically one of the major goals in any parafoil 100 design. Since the required lift of the parafoil 100 is set by the weight of the parafoil 100 and the payload 114, delivering that lift with lower drag leads directly to better fuel economy, climb performance, and glide ratio. The L/D is calculated for any particular airspeed by measuring the lift generated, then dividing by the drag at that speed. L/D ratios may also be calculated using the measured or determined differential pitch and/or differential pitch rate. Based on the calculated L/D ratio, the flight control system 200 may control the flight inputs for an optimal L/D ratio. Further, a combination of the determined differential yaw and a measured ground track direction may be used by the flight control system 200 to determine wind direction. Based on the determination of wind direction, the flight control system 200 may be configured to control the flight inputs. As example, the flight control system 200 may be configured to provide the flight inputs to the actuators 210A, 210B for achieving an optimal L/D ratio or in controlling the parafoil 100 for an optimal flight path based on the determined wind direction.

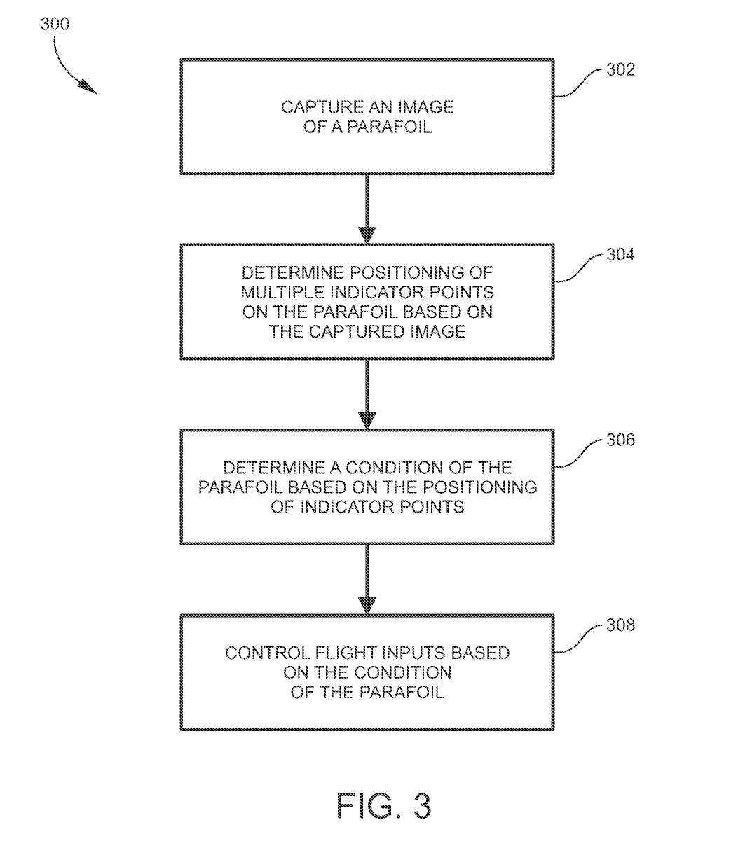

FIG. 3 illustrates a flowchart of an example method 300 of controlling the flight of a parafoil 100 and payload 114 using a flight control system 200 according to embodiments of the present subject matter. In this example, reference is made to the parafoil 100, payload 114 and flight control system 200 depicted in FIG. 2, although it should be understood that the method may alternatively be applied to any suitable parafoil, payload, and flight control system.

Referring to FIG. 3, the method includes capturing 302 a digital image of the parafoil 100 by the digital imaging device 206. The digital image may be of the parafoil 100 as viewed from the perspective of the payload 114, as an example. The method may include determining 304 the position of the plurality of indicator points 208 on the parafoil 100 based on the captured digital image. The position of the indicator points 208, as described below, may be determined by a digital image processor (not shown) in the computing device 202. The method may further include determining 306 a condition of the parafoil 100 based on the positioning of the plurality of indicator points 208. The condition of the parafoil 100 may be of the parafoil 100 itself, such as, a partial collapse of the parafoil 100 as an example. The condition may also be of a position of the indicator points 208 mounted on the parafoil 100 as indicative of the position of the parafoil 100 relative to the digital image frame of the digital image device 206. The method includes controlling 308 flight inputs based on the condition of the parafoil 100. The flight inputs are used to control the flight path of the parafoil 100 and the payload 114 and may be provided to the plurality of actuators 210A, 210B, as an example.

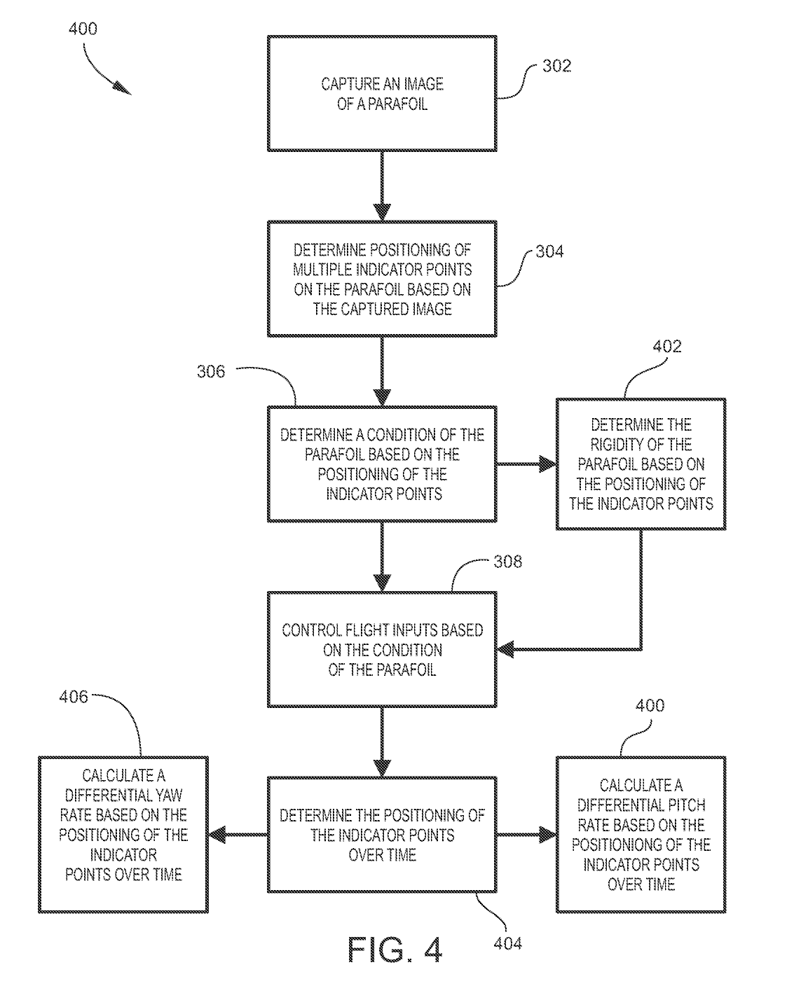

FIG. 4 illustrates a flowchart of an example method 400 of controlling the flight of the parafoil 100 and payload 114 using a flight control system 200 in accordance with embodiments of the present subject matter. In this example, reference is made to the parafoil 100, payload 114 and flight control system 200 depicted in FIG. 2, although it should be understood that the method may alternatively be applied to any suitable parafoil, payload, and flight control system. Controlling the flight of the parafoil 100 and payload 114 using a flight control system 200, may be performed by determining differential pitch and differential yaw according to embodiments of the present subject matter.

Referring to FIG. 4, in a similar fashion to FIG. 3, the method includes capturing 302 an image of the parafoil 100. The image may be of the parafoil 100 as viewed from the perspective of the payload 114, as an example. Alternatively, the image may be of the payload 114 from the perspective of the parafoil 100, as an additional example. The method may include determining 304 the position of a plurality of indicator points 208 on the parafoil 100 based on the captured image. The method may further include determining 306 a condition of the parafoil 100 based on the positioning of the plurality of indicator points 208. The method includes controlling 308 flight inputs based on the condition of the parafoil 100. The flight inputs may be provided to actuators 210A, 210B.

With continued reference to FIG. 4, the method may also include determining 402 the rigidity of the parafoil 100 based on the positioning of the indicator points 208. In aerodynamics, a flight envelope or performance envelope of the parafoil 100 refers to the capabilities of a particular design or the flight control specifications in terms of airspeed, load factor, and/or turning capabilities. Additionally, the flight envelope refers to other measurements such as maneuverability, stall speed, and the like. Expanding the flight envelope or pushing the parafoil 100 beyond the intended or designed performance of the parafoil 100 may increase the likelihood that the parafoil 100 will collapse. The collapse of the parafoil 100 may be due to a leading edge fold overs or stalling, as an example. Feedback to the flight control system 200 regarding the state or status of the parafoil 100 may indicate to the flight control system 200 that control inputs should be adjusted when disturbances to the parafoil 100 are detected. By monitoring the state or status of the parafoil 100 and adjusting the control inputs accordingly will allow the flight control system 200 to reduce the margin in the flight envelope that must be maintained when no indication of parafoil 100 failure is detected, thus increasing potential flight envelope performance.

With continued reference to FIG. 4, the method includes determining the rigidity of the parafoil 100 based on the positioning of the indicator points 208. If it is determined the current rigidity of the parafoil 100 requires correction to avoid failure, the flight control system 200 may be configured to make the necessary adjustments. The necessary adjustments may include adjusting or controlling the actuators 210A, 210B or the at least one propulsion means 212A, 212B independently of each other as appropriate. The method also includes determining 404 the positioning of the plurality of the indicator points over time. In this manner, the flight control system 200 may determine differential data over time. The differential data may include differential pitch and differential yaw. Yaw is the rotation or movement around the yaw axis of a rigid or semi-rigid body that changes the direction or heading of the rigid or semi-rigid body, such as the parafoil 100 or payload 114. A differential yaw is the angular difference between the heading of the parafoil 100 and the payload 114 as indicated by the digital imaging device 206. The method may also include calculating 406 a differential yaw either in a singular image or continuously over time determining the differential yaw rate based on the changing positioning of the plurality of indicator points over time. As an example, the flight control system 200 may be configured to maintain the differential yaw within a pre-determined value from between zero (0) to ten (10) degrees, as an example. The flight control system 200 may also be reprogrammed to adjust the pre-determined differential yaw range, as a non-limiting example, to twenty-five (25) degrees where conditions or equipment allow. It should be noted that the upper limit may be any appropriate limit as either conditions or equipment allow. The differential yaw range may also be changed in flight, in contrast to the pre-determined differential yaw range. Determining the differential yaw and the differential yaw rate may be used to damp out yaw perturbations, especially those caused at take-off and hard turns. Additionally, differential thrust adjustments by the flight control system 200 may be especially effective to control yaw perturbations.

Pitch is the rotation about the pitch axis of a rigid or semi-rigid body that changes the direction of the climb angle of the rigid or semi-rigid body. A differential pitch is the angular difference between the pitch of the parafoil 100 and the digital imaging device 206. The method may also include calculating 408 a differential pitch either in a singular image or continuously over time determining the differential pitch rate based on the positioning of the plurality of indicator points over time. As an example, the flight control system 200 may be configured to maintain the pre-determined differential pitch from between zero (0) to twenty (20) degrees, as an example. The flight control system 200 may also be reprogrammed to adjust the differential pitch range, as a non-limiting example, to twenty-five (25) degrees where conditions or equipment allow. It should be noted that the upper limit may be any appropriate limit as either conditions or equipment allow. The differential pitch range may also be changed in flight, in contrast to the pre-determined differential pitch range. Determining the differential pitch and differential pitch rate improves the altitude control of the flight control system 200, by decreasing the oscillations due to control input latency or perturbations. Additionally, time-varying thrust adjustments by the flight control system 200 may be especially effective to control or mitigate pitch perturbations. This method of pitch differential measurement may also be used to record measurement data for determining the lift-to-drag of the parafoil 100 and may be used where an intentional morphing of the parafoil 100 is desired. The intentional morphing of the parafoil 100 may be used to change the aerodynamic properties of the parafoil 100. As an example, intentional morphing of the parafoil 100 may be used to change the performance of the parafoil 100 using varying flight speeds.

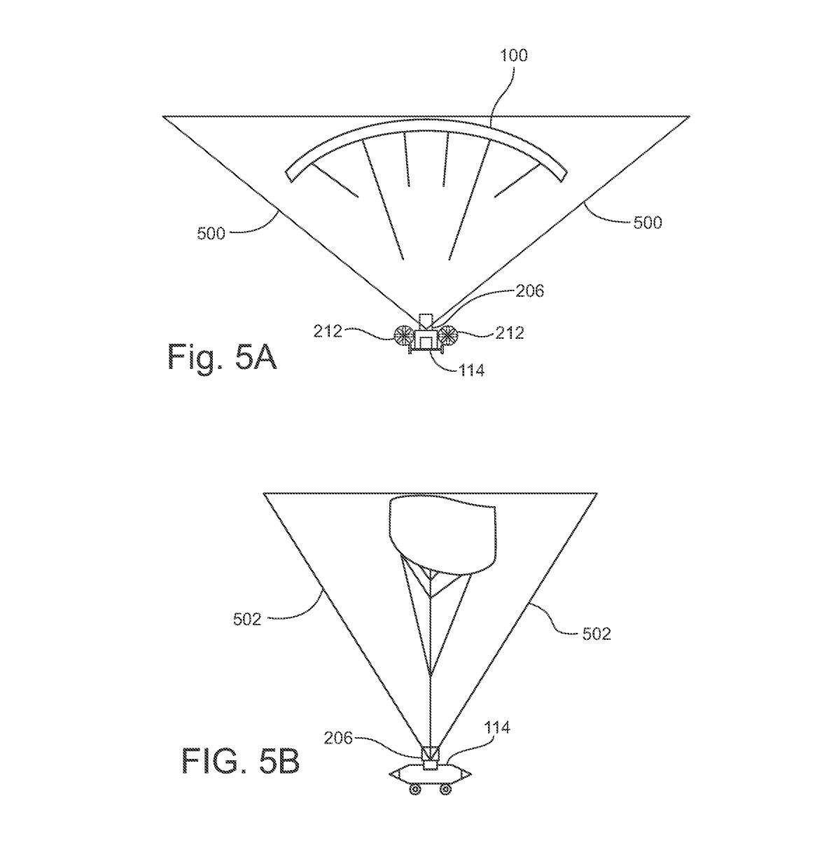

FIG. 5A illustrates a front view of an example flight control system in accordance with embodiments of the present subject matter. Referring to FIG. 5A, the figure shows a front view angle 500 of the digital imaging device 206. The digital imaging device 206 may capture images of the parafoil 100 according to embodiments of the present subject matter. The digital imaging device 206 of the flight control system 200 may be mounted on the top of the payload 114 and configured to capture images of the parafoil 100. FIG. 5A also shows the front viewing angle 500 from the front perspective of the payload 114. In this manner, the digital imaging device 206 is able to view the indicator points 208 mounted on the parafoil 100 and determine the corresponding shape, the rigidity, the differential yaw, and the differential pitch.

FIG. 5B illustrates a side view of the system shown in FIG. 5A. Referring to FIG. 5B, the figure shows a side view angle 502 of the digital imaging device 206. In this manner, the digital imaging device 206 may be able to view the parafoil 100 and determine the corresponding the shape, the rigidity, the differential yaw and the differential pitch.

FIG. 6A is a perspective view showing an example of the flight control system 200 determining differential yaw in accordance with embodiments of the present subject matter. In this example illustration, a differential yaw 600 as measured between the yaw angle of the parafoil 100 and the digital imaging device 206 as indicated by the indicator points 208 is −11.6 degrees. Based on this determination, the flight control system 200 may adjust the control inputs to reduce or increase the differential yaw 600 as appropriate for the current or anticipated flight conditions. It should be noted that based on the calculation of the differential yaw rate of change, the flight control system 200 may make adjustments to the control inputs based on anticipated flight conditions.

FIG. 6B is a perspective showing an example of the flight control system 200 determining differential pitch by imaging the parafoil 100 as viewed from the perspective of the payload (gondola). In this example illustration, a differential pitch 602 between the pitch angle of the parafoil 100 and the frame of the image captured by the digital imaging device 206 as indicated by the indicator points 208 is −10.5 degrees. As an example, the differential pitch 602 may be measured based on the angular distance from the digital image frame edge of the digital image device 206 and a center point on a virtual line imaged based on the indicator points 208. Based on this determination, the flight control system 200 may adjust the control inputs to reduce or increase the differential pitch 602 as appropriate for the current or anticipated flight conditions. It should be noted that based on the calculation of the differential pitch rate the flight control system 200 may make adjustments to the control inputs based on anticipated flight conditions.

FIG. 6C is a perspective view showing an example of the flight control system 200 determining parafoil deformation. As an example, parafoil deformation may be determined by the flight control system 200 as a loss of rigidity of the parafoil 100. In response to the determined loss of rigidity of the parafoil 100, the flight control system 200 may be configured to adjust the propulsion means 212A, 212B to increase air flow, thus reinflating the parafoil 100 and reestablishing rigidity, as an example. The flight control system 200 may also be configured to adjust the actuators 210A, 210B such that a turning radius of the parafoil 100 is decreased or increased, as a further example. It should be noted that based on the calculation of the parafoil 100 deformation the flight control system 200 may make adjustments to the control inputs based on anticipated flight conditions. Tracking the shape of the parafoil 100 over time may allow for increased turn rates, improving lateral control. Additionally, tracking the shape of the parafoil 100 over time may be used as parafoil 100 speed is increased.

The present subject matter may be implemented as a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
capturing an image of a parafoil including a plurality of indicator points distributed thereon;
determining positioning of the indicator points based on the captured image;
determining a condition of the parafoil based on the positioning of the indicator points; and
controlling flight inputs based on the condition of the parafoil.

2. The method of claim 1, further comprising determining the rigidity of the parafoil based on the positioning of the indicator points.

3. The method of claim 1, further comprising:
determining the positioning of the indicator points over a predetermined period of time; and
calculating a differential yaw rate based on the positioning of the indicator points over the predetermined period of time.

4. The method of claim 1, further comprising calculating a differential yaw based on the positioning of the indicator points.

5. The method of claim 4, further comprising determining wind direction based on the calculated differential yaw and a ground track direction.

6. The method of claim 5, further comprising controlling flight inputs based on the determined wind direction.

7. The method of claim 1, further comprising:
determining the positioning of the indicator points over a predetermined period of time; and
calculating a differential pitch rate based on the positioning of the indicator points over the predetermined period of time.

8. The method of claim 1, further comprising calculating a differential pitch based on the positioning of the indicator points.

9. The method of claim 8, further comprising calculating the lift-to-drag ratio based on the calculated the differential pitch.

10. The method of claim 8, further comprising controlling flight inputs based on the calculated differential pitch.

11. The method of claim 1, further comprising positioning an imaging device substantially near the center of a gondola for capturing the image of the parafoil.

12. The method of claim 1, further comprising determining whether a differential yaw is greater than a predetermined value.

13. The method of claim 12, wherein controlling the flight inputs based on the condition of the parafoil comprises controlling a turning rate of the parafoil in response to determining that the differential yaw is greater than the predetermined value.

14. The method of claim 12, wherein controlling the flight inputs based on the condition of the parafoil comprises controlling a propulsion force for adjusting the turning rate of a coupled gondola in response to determining that the differential yaw is greater than the predetermined value.

15. The method of claim 1, wherein controlling the flight inputs comprises creating a drag force on a first side of the parafoil.

16. The method of claim 4, wherein controlling the differential yaw comprises adjusting a plurality of propulsion forces.

17. The method of claim 6, wherein controlling the differential pitch comprises adjusting at least one propulsion force

18. The method of claim 14, wherein controlling the propulsion force for adjusting the turning rate comprises using a first fan and a second fan for propulsion of the parafoil, and
wherein controlling the flight inputs comprises controlling either the first fan or the second fan.

19. A system comprising:
a parafoil including a plurality of indicator points distributed thereon;
a digital imaging device configured to capture an image of the indicator points;
a computing device comprising at least one processor and memory configured to:
determine positioning of the indicator points based on the captured image;
determine a condition of the parafoil based on the positioning of the indicator points; and
control flight inputs based on the condition of the parafoil.

20. The system of claim 19, wherein the computing device is further configured to determine the rigidity of the parafoil based on the positioning of the indicator points.

21. The system of claim 19, wherein the computing device is further configured to:
determine the positioning of the indicator points over a predetermined period of time; and
calculate a differential yaw rate based on the positioning of the indicator points over the predetermined period of time.

22. The system of claim 19, wherein the computing device is further configured to:
calculate a differential yaw based on the positioning of the indicator points.

23. The system of claim 22, wherein the computing device is further configured to determine wind direction based on the calculated differential yaw and a ground track direction.

24. The system of claim 23, wherein the computing device is further configured to control flight inputs based on the determined wind direction.

25. The system of claim 19, wherein the computing device is further configured to:
determine the positioning of the plurality of indicator points over a predetermined period of time; and
calculate a differential pitch rate based on the positioning of the indicator points over the predetermined period of time.

26. The system of claim 19, wherein the computing device is further configured to:
calculate a differential pitch based on the positioning of the indicator points.

27. The system of claim 26, wherein the computing device is further configured to use the calculated differential pitch to calculate the lift-to-drag ratio.

28. The system of claim 26, wherein the computing device is further configured to control flight inputs based on the calculated differential pitch.

29. The system of claim 19, wherein the digital imaging device is positioned substantially near the center of a gondola.

30. The system of claim 19, wherein the computing device is further configured to determine whether a differential yaw is greater than a predetermined value.

31. The system of claim 30, wherein the computing device is further configured to control a turning rate of the parafoil in response to determining that the differential yaw is greater than the predetermined value.

32. The system of claim 31, further comprising:
at least one fan for propulsion of the parafoil, and
wherein the computing device is further configured to control a plurality of propulsion forces for adjusting the differential yaw.

33. The system of claim 31, further comprising:
at least one propulsion force for propulsion of the parafoil, and
wherein the computing device is further configured to control the at least one propulsion force for adjusting the differential pitch rate.

34. The system of claim 19, wherein the computing device is configured to control the flight inputs to create a drag force on a first side of the parafoil.

35. The system of claim 19, further comprising at least one fan for propulsion of the parafoil.

36. The system of claim 19, further comprising:
a first fan and a second fan for propulsion of the parafoil, and
wherein the computing device is configured to control the flight inputs by controlling either the first fan or the second fan.
